(19) United States
(12) Patent Application Publication
(10) Pub. No.: US 2012/0036973 A1
(43) Pub. Date: Feb. 16, 2012

(54) APPARATUS FOR PROCESSING A MATERIAL WEB

(75) Inventor: PETER EISEMANN, Simmozheim (DE)

(73) Assignee: Mueller Martini Holding AG, Hergiswil (CH)

(21) Appl. No.: 13/019,396

(22) Filed: Feb. 2, 2011

(30) Foreign Application Priority Data
Feb. 4, 2010 (EP) 10152656.4

(51) Int. Cl. B26D 1/40; B21D 28/14

(52) U.S. Cl. 83/346; 83/670

(57) ABSTRACT

An apparatus for processing a material web transported in a longitudinal direction through the apparatus includes a machine frame, an anvil cylinder positioned in the machine frame and rotatable around a first axis; and a tool cylinder positioned in the machine frame and rotatable around a second axis. The first and second axes of rotation are respectively oriented transverse to the longitudinal direction and parallel to the material web. The anvil cylinder and the tool cylinder are rotatable toward each other so that the material web can be guided between the anvil cylinder and the tool cylinder. The anvil cylinder and the tool cylinder are pivotally mounted to deviate by the same angle from a right angle to the longitudinal direction.

### CROSS-REFERENCE TO RELATED APPLICATION

This application claims the priority of European Patent Application No. 10152656.4, filed on Feb. 4, 2010, the subject matter of which is incorporated herein by reference.

### BACKGROUND OF THE INVENTION

The invention relates to an apparatus for processing a material web that is transported in a longitudinal direction through the apparatus. A known apparatus of this type includes a machine frame in which an anvil cylinder is positioned rotating around a first axis and a tool cylinder is positioned rotating around a second axis. The axes of rotation are respectively oriented transverse to the longitudinal direction and parallel to the material web. The anvil cylinder and the tool cylinder can rotate toward each other and, in the process, the material web can be guided through between the anvil cylinder and the tool cylinder. Apparatuses of the aforementioned type are are used, for example, for the cutting and perforating of material webs in web-fed rotary presses. German patent document DE 19927920 discloses an apparatus intended to function as a cutting device in the folding arrangement of a web-fed rotary press. European patent document EP 1186561 relates to an apparatus for the processing and, in particular, for the cutting and perforating of a material web, for which a working cylinder cooperates with an immovably positioned counter blade.

Comparatively high forces are generated during the punching, cutting and/or perforating of material webs with the aid of cooperating, jointly rotating working cylinders, wherein these forces are carried away by corresponding tools. These forces increase with decreasing sharpness of the tool. Since the working cylinders are positioned only with their ends in bearing locations, a certain amount of deflection of the work cylinders cannot be avoided in-between the bearing locations on the machine frame. However, even a comparatively small deflection of the working cylinders can result in reducing the punching, cutting and/or perforating quality. This deflection and the therewith associated reduction in quality is comparatively high, especially for work cylinders having a small diameter.

European patent document EP 1818299 A1 discloses an apparatus for processing material webs with the aid of anvil and/or work cylinders that are arranged or can be arranged crosswise, relative to each other. As a result of such a crosswise arrangement of the work cylinders, it is possible to considerably reduce the forces required for the processing since each time only a portion of the work cylinder comes in contact with the material web and/or the anvil cylinder during the processing. A successive insertion of the tools into the material web can be achieved in this way. A further advantage of this apparatus is that as a result of the crossed arrangement, a deflection of the work cylinder in particular can be compensated for because the axial distance between the centers of the two working cylinders is reduced while it remains unchanged at the ends of the working cylinders. Thus, the axial spacing in the center between the two working cylinders is purposely influenced with the crosswise arrangement.

With this apparatus, both ends of the operating surface for the working cylinder are provided with bearer rings, by which the working cylinders roll off each other. The bearer rings respectively comprise a cylindrical roll-off surface, so that the working cylinders can roll off each other with precision, respectively off the material web guided between the cylinders, even if the cylinders are arranged crosswise. Alternatively, the bearer rings can also be embodied conically, so as to allow a defined adjustment of the distance between the operating surfaces of the working cylinders, relative to each other, through an axial displacement of the bearer rings. Owing to the fact that the two working cylinders are adjusted toward each other in a crossed arrangement, the movement direction of the bearer rings changes, relative to each other. Instead of the bearer rings rolling off parallel along a line, a point-type contact results which causes heavier wear to the bearer rings.

Since the adjustment of the working cylinders with the aid of bearer rings has advantages, solutions to the aforementioned problems were searched for in the past already, without having to use a crossed arrangement of the working cylinders relative to each other. In general, however, there are problems with magnetic cylinder inserts in which the working cylinders are arranged parallel to each other and perpendicular to the movement direction of the material web. For example, a non-uniform heating up occurs of the respective cylinder bodies, and vibrations develop as a result of the necessarily high pressure between the anvil cylinder and the work cylinder. In addition to the crosswise arrangement of the working cylinders, attempts have also been made to solve these problems with the aid of cooling, or an improved positioning of the working cylinders, or with a spherical design for the anvil cylinder. These solutions, however, are relatively involved and thus also expensive.

### SUMMARY OF THE INVENTION

It is an object of the present invention to create a simple and cost-effective apparatus for processing material webs, but which nevertheless makes it possible to achieve good quality during the punching, cutting and/or perforating of the material webs.

The above and other objects are accomplished according to the invention wherein, in one embodiment, there is provided an apparatus for processing a material web transported in a longitudinal direction through the apparatus, comprising: a machine frame; an anvil cylinder positioned in the machine frame and rotatable around a first axis; a tool cylinder positioned in the machine frame and rotatable around a second axis, wherein the first and second axes of rotation are respectively oriented transverse to the longitudinal direction and parallel to the material web, and wherein the anvil cylinder and the tool cylinder are rotatable toward each other so that the material web can be guided between the anvil cylinder and the tool cylinder, and further wherein the anvil cylinder and the tool cylinder are pivotally mounted to deviate by the same angle from a right angle to the longitudinal direction.

Thus, according to the invention, the two working cylinders have a slanted positioning, meaning the two working cylinders are positioned at the same angle relative to the movement direction of the material web. The working cylinders therefore can roll off each other in the same way as for a conventional arrangement in which the working cylinders are arranged perpendicular to the movement direction. A successive insertion of the tools into the material web can still be realized through a corresponding design of the punching, cutting or perforating die.

That is, the generic apparatus includes a machine frame through which the material web can be transported in a longitudinal direction. In the machine frame, an anvil cylinder is arranged so as to rotate around a first axis of rotation and a tool cylinder is positioned so as to rotate around a second axis of rotation, wherein the axes of rotation are respectively arranged transverse to the longitudinal direction and parallel to the material web. The anvil cylinder and the tool cylinder can be rotated toward each other, so that the material web can be guided through between the anvil cylinder and the tool cylinder.

According to the invention, the anvil cylinder and the tool cylinder can be pivoted to the identical angled position. In this angled position, the axes of rotation for the two working cylinders are also oriented transverse to the longitudinal direction and parallel to the material web, however the working cylinders are positioned to deviate by the same angle from a right angle relative to the longitudinal direction.

In the angled position, the working cylinders are consequently arranged parallel to each other. As a result, the punching, cutting or perforating die can “roll off” the anvil cylinder that is also positioned at an angle, parallel to the tool cylinder. Fewer vibrations occur with this arrangement than with a solution where the working cylinders are arranged crosswise, relative to each other, thereby resulting in an improved processing quality for the material web. The positioning angle with respect to a direction perpendicular to the longitudinal directions may be, for example, 1°-2°, but can also differ if necessary. Thus, conical bearer rings can advantageously continue to be used for adjusting the spacing between the working surfaces of the working cylinder and the anvil cylinder.

The vibrations generated during the punching, cutting or perforating operation are advantageously compensated for in that the tools for producing the cutting edges, which extend perpendicular to the material web, of the corresponding punching, cutting or perforating patterns do not abruptly, and over the total cylinder length, come in contact with the anvil cylinder. Rather, a contact with the anvil cylinder only occurs at the moment when the tool rolls off, meaning during the respectively engaged segment. This can be achieved by producing the punching, cutting or perforating dies with a defined geometric distortion factor, corresponding to the angled position of the two working cylinders, relative to the material web. Owing to the parallel positioning at the same angle of the two working cylinders, a successively progressing point-type contact takes place instead of the line-type contact, which has occurred so far, between the material web and the punching, cutting or perforating dies when the tools for the punching, cutting or perforating dies are inserted into the material web and a line-type contact occurs in place of a point-type contact between the bearer rings. As a result, the forces on the working cylinders can advantageously be reduced and the service life of the tools and the bearer rings can be increased while, simultaneously, the punching, cutting or perforating quality is improved as a result of a smaller deflection of the working cylinders and of a reduction in the tendency to vibrate.

With a conventional parallel arrangement of the two working cylinders, the deflection is increased across the width of the working cylinder because of the line-type contact of the punching, cutting or perforating pattern. The invention avoids such a line-type contact without having to position the working cylinders crosswise to each other.

With the angled positioning according to the invention for the two working cylinders, a local deflection of the material web that is guided between the two cylinders should be expected, relative to its global movement direction. That is the case because the material web is guided frictionally adhering over nearly its total length in a joint contact region for the working cylinders. As a result of the angled positioning of the working cylinders, the region of contact for these cylinders, relative to the global movement direction of the material web, is also positioned at an angle.

The expected drifting of the material web as a result of a certain deflection just prior to the region of contact for the working cylinders is taken into consideration when designing the punching, cutting or perforating patterns, which must generally be fitted across the circumference of the working cylinder. For example, the edge guidance of the tools on the punching, cutting or perforating dies is avoided, which favors a guidance of the material web. If a drifting of the material web is nevertheless observed, advantageous embodiments make it possible to adjust the angled positioning during the operation of the apparatus, so that the coinciding angles of the two axes of rotation becomes smaller. However, the punching, cutting or perforation pattern must be adapted once more for large changes of this type.

Slight deflections of the paper web, which can be more or less strong depending on the punching, cutting or perforating pattern, can be tolerated and/or do not result in noticeable quality losses in the punching, cutting or perforation product.

According to a different, embodiment the anvil cylinder and the tool cylinder are positioned in end covers of the machine frame. The end covers may be provided with recesses while the anvil cylinder and the tool cylinder are arranged in a joint insert that is positioned in the recesses provided in the end covers. The latter comprises a sliding swing gate on the operator side, as well as a swing gate on the drive side, wherein the recess on the drive side is provided with a trunnion that engages in the insert. As a result of this arrangement, the working cylinders can advantageously be pivoted jointly with the aid of the insert to the angled position. A holder of this type ensures the adjustment of the working cylinders relative to each other without problem while the configuration of the machine frame is simplified.

The anvil cylinder and the tool cylinder according to a different embodiment are provided at each end with respectively one, for example, conically embodied bearer ring. A simple and defined adjustment of the distance between the working surfaces of the working cylinders is thus advantageously possible through an axial displacement of the bearer rings, relative to each other.

According to a different embodiment, a punching die with a punching pattern is detachably mounted on the tool cylinder. The punching pattern compensates for the angled positioning of the anvil cylinder and the tool cylinder.

The flexibility for designing the punching patterns offers cost advantages as compared to alternative punching concepts which do not provide for an angled positioning of the two working cylinders that participate in the punching process, wherein punching patterns are only mentioned as examples herein. The same is true for cutting and perforating tools, which can also be fitted in the form of the respective dies onto the tool cylinder. As a result, the tool cylinder of embodiments of the apparatus is intended for the punching, cutting or perforating.

If rectangular punching fields are to be generated in the material web, one embodiment of the tool for the punching pattern takes the form of parallelograms. These are generated through a parallel displacement of one of the sides extending transverse to the axis of rotation, of an image of the rectangular punching fields, as seen in the circumferential direction. These types of punching patterns, suitable for adapting to the respective angled position, can be realized cost-effectively.

The anvil cylinder and the tool cylinder for a different embodiment are each driven with the aid of a separate drive. The individual drive, may be for example, a servo-drive which permits a simple adaptation to different angled positions for the working cylinders. Alternatively, the anvil cylinder can also drive the tool cylinder.

The apparatus may be used for the punching, cutting or perforating of an endless paper web. The two above-described punching dies can generally be used with tool cylinders that are positioned at an angle.

### BRIEF DESCRIPTION OF THE DRAWINGS

These and other features and advantages of the invention will be further understood from the following detailed description of embodiments with reference to the accompanying drawings.

FIG. 1 is a perspective partial view of an apparatus for processing a material web;

FIG. 2 is a A schematic representation of the working cylinders used in a conventional apparatus;

FIG. 3 is a schematic representation of an apparatus according to the invention, with working cylinders that are offset by respectively the same amount;

FIG. 4 is a schematic view from above of a tool cylinder fitted with a conventional punching die, shown in a conventional orientation with the material web guided underneath;

FIG. 5 is a schematic view from above of a tool cylinder fitted with thereon mounted punching die according to the invention, oriented according to the invention, with the material web guided underneath;

FIG. 6 is a view from above of a conventional punching die;

FIG. 7 is a view from above of the punching die shown in FIG. 6, with marking of a contact region between the anvil cylinder and the tool cylinder;

FIG. 8 is a view from above of an inventive punching die, in accordance with a first exemplary embodiment;

FIG. 9 is a view from above of the punching die shown in FIG. 8, with marking of a contact region between the anvil cylinder and the tool cylinder;

FIG. 10 is a view from above of a different conventional punching die;

FIG. 11 is a view from above of the punching die shown in FIG. 10, with marking of a contact region between the anvil cylinder and the tool cylinder;

FIG. 12 is a view from above of a punching die according to the invention, in accordance with a second exemplary embodiment;

FIG. 13 is a view from above of the punching die shown in FIG. 12, with marking of a contact region between the anvil cylinder and the tool cylinder;

FIG. 14 is a view from above of a section of a material web which has already been processed with the punching die shown in FIG. 6 or in FIG. 8; and

FIG. 15 is a view from above of a section of a material web that is being processed with a punching die as shown in FIG. 10 or in FIG. 12.

### DETAILED DESCRIPTION

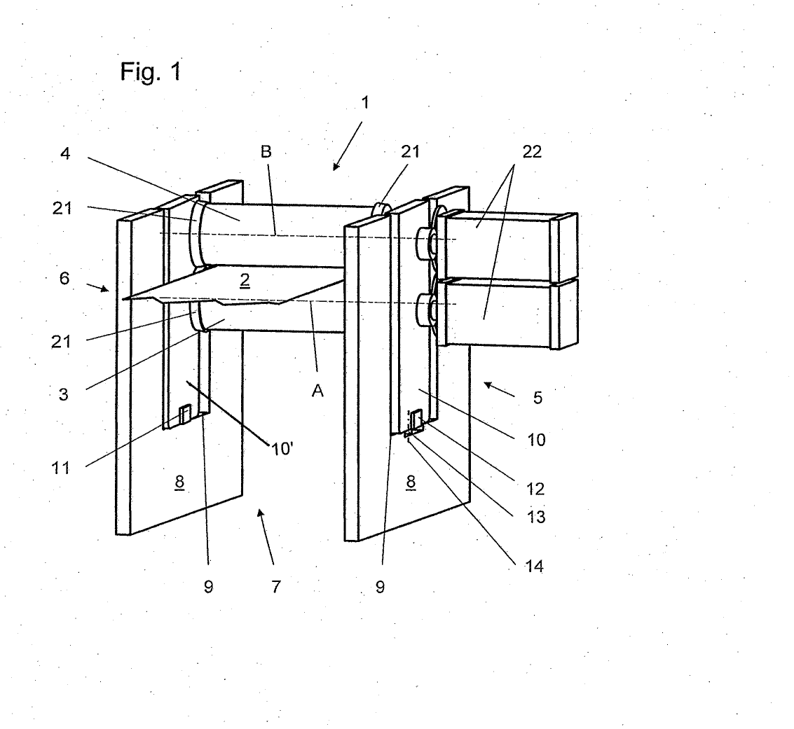

FIG. 1 shows a perspective partial view of an apparatus 1 according to the invention for processing a material web 2. The apparatus 1 is a punching apparatus, for example, which comprises working cylinders including an anvil cylinder 3 and a tool cylinder 4. These working cylinders are positioned in a standard manner in a machine frame 7 for the apparatus 1, comprising a drive side 5 and an operating side 6, wherein only an end cover 8 on both sides is shown. Recesses 9 are worked into the end covers 8. The anvil cylinder 3 and the tool cylinder 4 are each positioned jointly in inserts 10, 10′ which, in turn, are respectively arranged in the recesses 9 of the end covers 8. With the inserts 10, 10′ the two working cylinders can jointly be inserted into or removed from the apparatus 1. Once the inserts 10, 10′ are inserted into the apparatus 1, they can be considered components of the machine frame 7.

The two working cylinders rotate toward each other, so that the material web 2 is guided through between them. The anvil cylinder 3 in this case rotates around a first axis of rotation A and the tool cylinder 4 rotates around a second axis of rotation B.

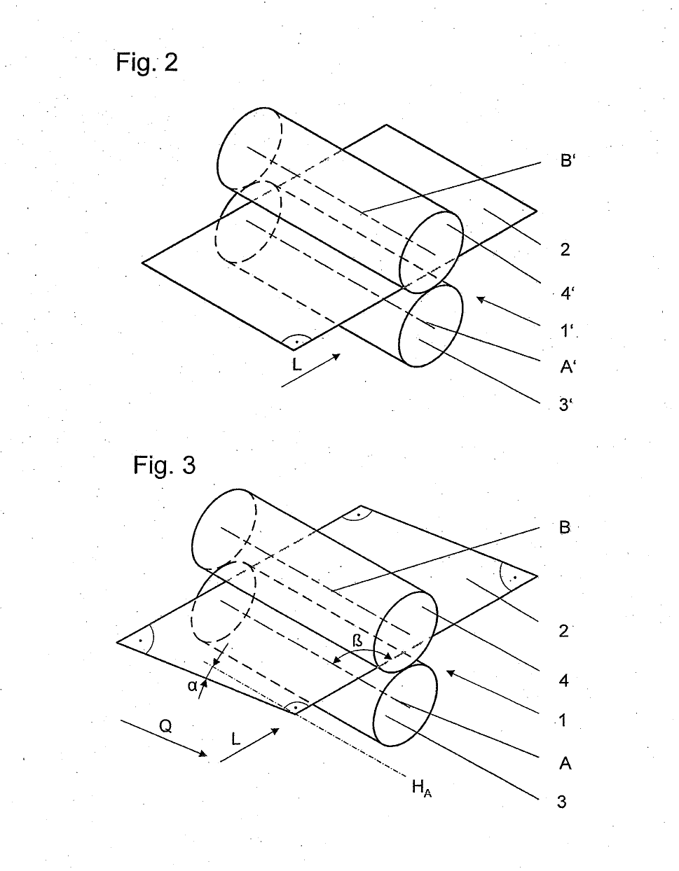

With an identically configured conventional apparatus 1′, as shown in FIG. 2, of which only the anvil cylinder 3′ and the tool cylinder 4′ are shown, the axes of rotation A′, B′ are oriented parallel to each other, parallel to the material web 2 and perpendicular to a longitudinal direction L of the material web 2, wherein the longitudinal direction L corresponds to the global movement direction of the material web 2.

FIG. 3, on the other hand, shows the apparatus 1 according to the invention, as shown in FIG. 1, in a representation that is identical to the one shown in FIG. 2. The material web 2 in this case is also transported in a longitudinal direction L through the apparatus 1, meaning with a rotating movement toward each other of the two working cylinders. In the same way as the axes of rotation A′, B′ of the working cylinders for the conventional apparatus 1′, the axes of rotation A, B for the anvil cylinder 3 and the tool cylinder 4 are oriented parallel to the material web 2 and transverse to the longitudinal direction L. However, according to the invention the axes of rotation A, B are not oriented perpendicular to the longitudinal direction L, but rather are both pivotally arranged to deviate by the same angle α from a right angle, relative to the longitudinal direction L. An auxiliary line H_{A} is drawn into FIG. 3 for illustrating this. The anvil cylinder 3 and the tool cylinder 4 are shown in the angled position according to the invention.

The two working cylinders are embodied such that they can be pivoted to a coinciding angled position. According to one advantageous embodiment, the working cylinders can be pivoted jointly to the angled position, in particular by being jointly positioned in the insert 10, wherein this insert is embodied such that it can be pivoted to the angled position. The insert 10′ is equipped for this with a sliding swing gate 11 on the operating side and insert 10 on the drive side is equipped with a swing gate 12. A trunnion 13 disposed in the recess 9 on the drive side engages in the insert 10 and has a pivoting axis 14. FIG. 1 shows the insert 10 and the working cylinders in the angled position.

In the angled position, the axes of rotation A, B of the working cylinders are arranged parallel to each other, but are not perpendicular to the longitudinal direction L. With reference to the longitudinal direction L, which must be viewed as the global movement direction for the material web 2, the axes of rotation A, B are oriented at an angle β which is unequal to 90°.

Even if the material web 2 is locally deflected around a joint contact region 15 (FIG. 9) of the two working cylinders during the operation of the apparatus 1, the global movement direction L can still be maintained.

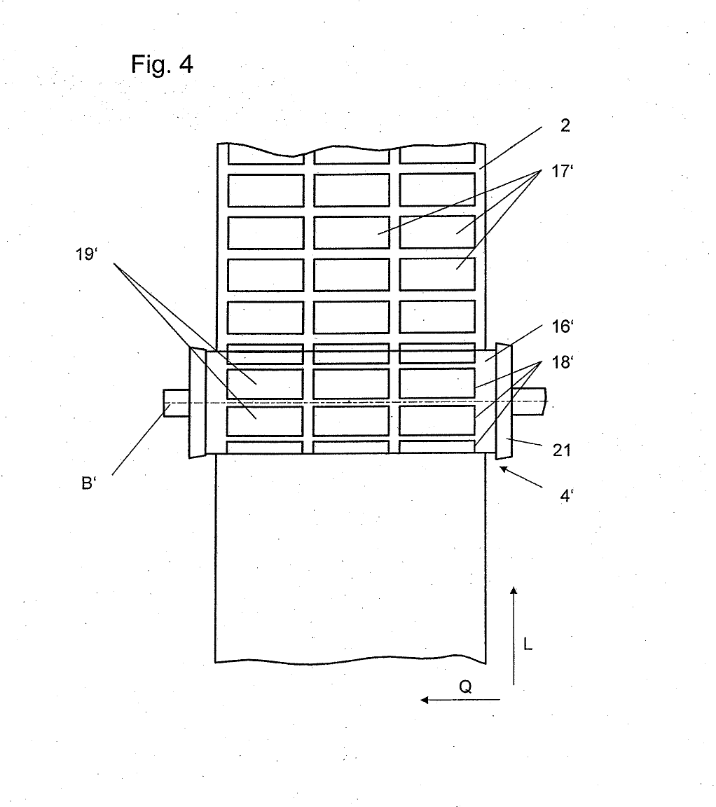

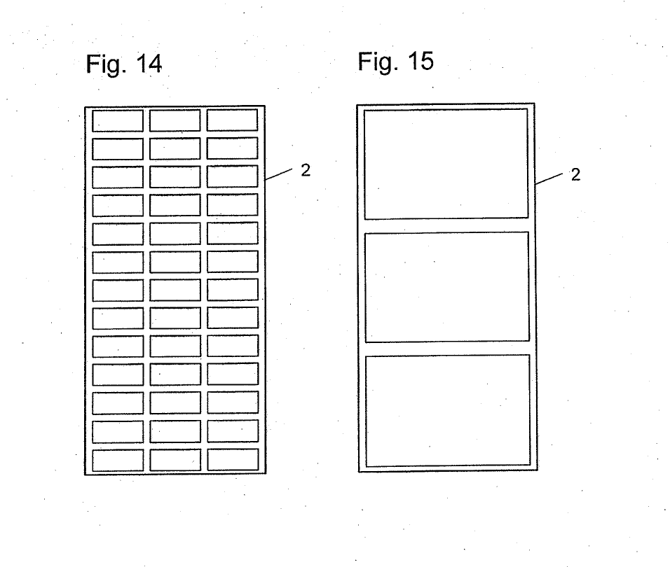

In FIGS. 4 to 9, a first embodiment of a punching die 16 according to the invention in the form of a punching plate is contrasted with a conventional punching die 16′. With the aid of the punching die 16, it is possible to compensate for a slanted positioning of the working cylinders by the angle α. With a conventional arrangement of the working cylinders, on the other hand, no compensation is required. As shown in FIG. 14, the same punching results can be achieved when using the punching die 16 according to the invention and the conventional punching die 16′. Of course, a corresponding apparatus 1 for processing a material web 2 can also be provided with a cutting die or a perforating die on the tool cylinder 4 in place of a punching die 16. Accordingly, the material web 2 can also be cut with a cutting die or can be perforated with a perforating die instead of being punched with the punching die 16, described as an example herein.

FIGS. 4, 6 and 7 relate to the conventional punching die 16′ to be fitted onto the conventional tool cylinder 4′. FIG. 4 shows in a view from above the tool cylinder 4′, equipped with the punching die 16′. Below tool cylinder 4′ is an anvil cylinder, which cannot be seen in the representation according to FIG. 4. The material web 2 is guided through between these two working cylinders in a longitudinal direction L. In a transverse direction Q, the working cylinders are oriented perpendicular to the longitudinal direction L. Rectangular punching fields 17′ are visible on the material web 2 which are punched into the material web 2 and which can represent labels. These punching fields 17′ correspond to the punching pattern 18′ on the punching die 16′ which forms the tool 19′ and, in the contact region 15′ (FIG. 7) of the working cylinders, is inserted into the material web 2.

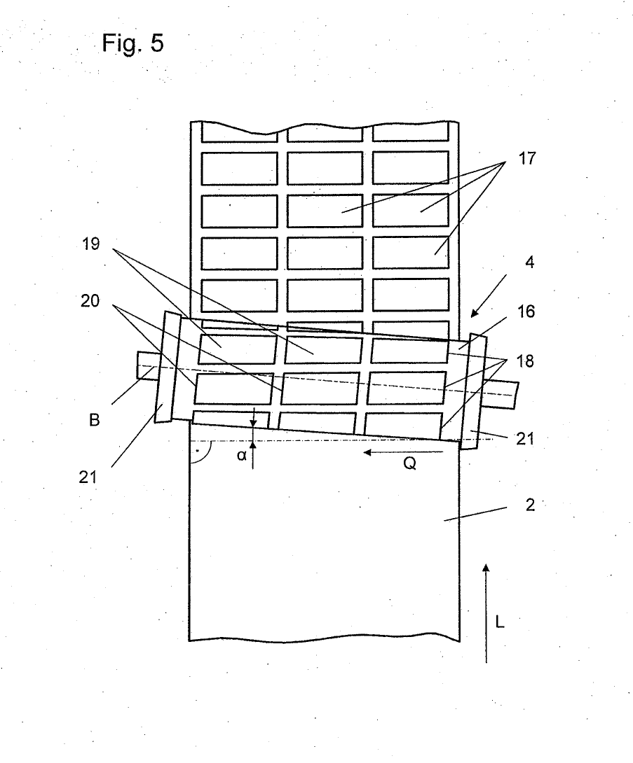

FIG. 5 shows the angled positioning of the working cylinders according to the invention in a representation that is comparable to the one shown in FIG. 4. The angled positioning of the working cylinders by an angle α, relative to the transverse direction Q that extends perpendicular to the longitudinal direction L of the material web 2, is compensated with the aid of a respective punching pattern 18 of the punching die 16. To produce rectangular punching fields 17 in the material web 2 which can be used as labels, for example, tools 19 that are embodied as parallelograms are arranged on the punching die 16. The shape of the tools 19 is created through a parallel displacement of one of the sides 20, extending transverse to the axis of rotation B, of an image of the rectangular punching fields 17 in circumferential direction of the working cylinder 4. The punching die 16 in this case takes the form of a parallelogram and is fitted onto the working cylinder 4. Accordingly, a non-depicted impact edge of the punching die 16 extends at an angle to the transverse direction Q. Alternatively, it is also conceivable to allow the impact edge to extend parallel to the axis of rotation A, B of the working cylinders. However, a crossing of the punching dies 16 over the impact edge is possible in that case, depending on the punching pattern 18. A corresponding embodiment is not shown herein.

The tool cylinder 4 and the anvil cylinder 3 are provided on the operating side as well as on the drive side with respectively one bearer ring 21. Both working cylinders are respectively driven with the aid of an individual drive 22 (FIG. 1) each of which is embodied as a servomotor. Of course, a conventional drive, not shown herein, via a gear train can also be used. In that case, the at least one anvil cylinder 3 is provided with respectively one narrow and/or a crowned gear. As an alternative to the use of servomotors, a direct drive can also be arranged on each axis of rotation A, B, for example with the aid of torque motors and without gear stepping.

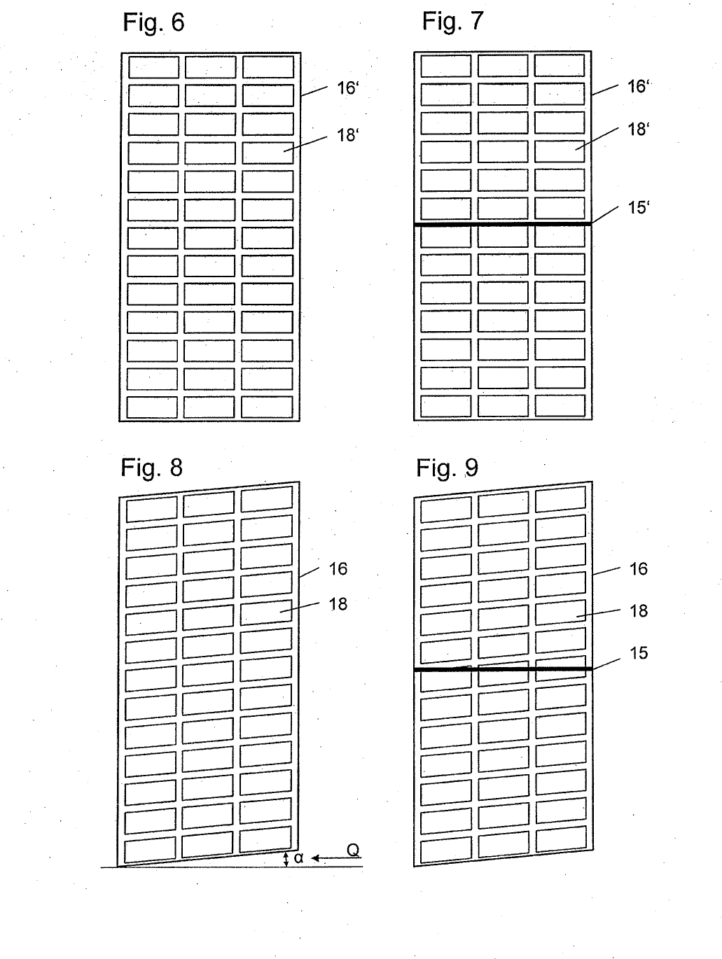

FIG. 6 shows a punching die 16′ with a punching pattern 18′ intended for the conventional tool cylinder 4′ shown in FIG. 4. In FIG. 7, the region of contact 15′ is shown with a black line on this punching pattern 18′, meaning the area where the material web 2 is guided through between the tool cylinder 4′ and the anvil cylinder 3′.

In the same way as FIGS. 6 and 7, FIGS. 8 and 9 show the punching die 16 to be fitted onto the tool cylinder 4 according to the invention. The angled positioning of the punching die 16 by the angle α, relative to the transverse direction Q, is clearly visible in that case, especially in the representation according to FIG. 9, wherein the marking is shown as a black line in the contact region 15 between the tool cylinder 4 and the anvil cylinder 3. The successively progressing point-type contact with the material web 2, which is not visible in FIG. 5 underneath the tool cylinder 4, is thus illustrated clearly.

FIG. 14 shows the result of the punching operation on the material web 2 for the two arrangements, meaning for the conventional apparatus as well as the inventive apparatus 1′, 1.

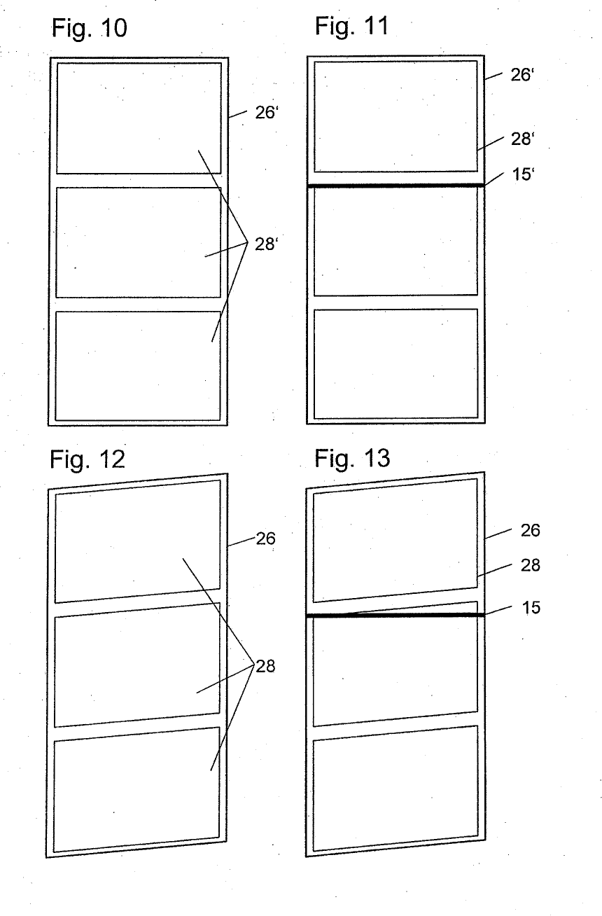

FIGS. 10 to 13 represent a second embodiment of a punching die 26, 26′. FIGS. 10 and 11 show the punching die 26′ with the punching pattern 28′ in the form of large rectangles for a conventional apparatus 1′. FIGS. 12 and 13, on the other hand, show as the second embodiment the punching die 26 according to the invention with the punching pattern 28 in the form of parallelograms.

Corresponding to FIGS. 7 and 9, the respective contact region 15′, 15 between the anvil cylinder and the tool cylinder 4′, 3′ and 4, 3, respectively, is marked in FIGS. 11 and 13. Analogous to FIG. 14, the punched material web 2 is shown in FIG. 15 following the punching operation with the aid of the conventional as well as the inventive apparatus 1′, 1 with a punching die 26′, 26.

Of course, differently shaped punching fields can also be produced, such as elliptical or also round punching fields, with the apparatus 1 when using a corresponding design for the tool.

It will be understood that the above description of the present invention is susceptible to various modifications, changes and adaptations, and the same are intended to be comprehended within the meaning and range of equivalents of the appended claims.

What is claimed is:

1. An apparatus for processing a material web transported in a longitudinal direction through the apparatus, comprising:
a machine frame;
an anvil cylinder positioned in the machine frame and rotatable around a first axis;
a tool cylinder positioned in the machine frame and rotatable around a second axis, wherein the first and second axes of rotation are respectively oriented transverse to the longitudinal direction and parallel to the material web, and wherein the anvil cylinder and the tool cylinder are rotatable toward each other so that the material web can be guided between the anvil cylinder and the tool cylinder, and further wherein the anvil cylinder and the tool cylinder are pivotally mounted to deviate by the same angle from a right angle to the longitudinal direction.

2. The apparatus according to claim 1, further including a punching, cutting, or perforating die removably attached on the tool cylinder, wherein the die has a punching, cutting, or perforating pattern that compensates for the angled positioning of the anvil cylinder and the tool cylinder.

3. The apparatus according to claim 2, wherein the punching, cutting, or perforating pattern for creating rectangular punching, cutting, or perforating fields in the material web comprises tools in a form of parallelograms generated through a parallel displacement of one of the sides, extending transverse to the second axis, of an image of the rectangular punching, cutting, or perforating fields in a circumferential direction of the tool cylinder.

4. The apparatus according to claim 1, wherein the machine frame includes opposing end covers in which the anvil cylinder and the tool cylinder are positioned.

5. The apparatus according to claim 4, wherein the end covers include recesses, and the machine frame includes inserts located, respectively, in the recesses, wherein the anvil cylinder and the tool cylinder are jointly positioned in the inserts.

6. The apparatus according to claim 5, wherein one of the end covers is on a drive side of the apparatus and the other of the end covers is on an operating side of the apparatus, the inserts on the operating and drive sides each include a sliding swing gate, and the end cover on the drive side includes a trunnion in the recess that engages in the insert.

7. The apparatus according to claim 1, further including conical bear rings positioned, respectively, at each end of the tool cylinder and the anvil cylinder.

8. The apparatus according to claim 1, further including individual drives arranged to drive the anvil cylinder and the tool cylinder, respectively.

9. The apparatus according to claim 8, wherein the individual drives comprise servo drives.

10. The apparatus according to claim 1, wherein the tool cylinder is adapted for punching, cutting or perforating.

11. The apparatus according to claim 1, wherein the apparatus is adapted to process an endless paper web.

12. A punching die for a tool cylinder in an apparatus according to claim 2, wherein the die is adapted to be removably attached on the tool cylinder and has a punching, cutting, or perforating pattern that, in operation, compensates for the angled positioning of the anvil cylinder.

13. The die according to claim 12, wherein the punching, cutting, or perforating pattern for creating rectangular punching, cutting, or perforating fields in the material web comprises tools in a form of parallelograms generated through a parallel displacement of one of the sides, extending transverse to the second axis of the tool cylinder, of an image of the rectangular punching, cutting, or perforating fields in a circumferential direction of the tool cylinder.
